(19) United States
(12) Patent Application Publication
(10) Pub. No.: US 2017/0169461 A1
(43) Pub. Date: Jun. 15, 2017

(54) PROMOTION SYSTEM AND PROMOTION METHOD

(71) Applicant: BEIJING KNET EQXIU TECHNOLOGY CO., LTD., BEIJING (CN)

(72) Inventors: JIN HUANG, BEIJING (CN); DIANSHENG LU, BEIJING (CN); WEI MAO, BEIJING (CN); DI MA, BEIJING (CN); WEI WANG, BEIJING (CN); WEIMING ZHU, BEIJING (CN); XU LIU, BEIJING (CN); YI TANG, BEIJING (CN)

(21) Appl. No.: 15/149,057

(22) Filed: May 6, 2016

(30) Foreign Application Priority Data
Dec. 15, 2015 (CN) 201510930078.8

(51) Int. Cl. G06Q 30/02

(52) U.S. Cl. CPC G06Q 30/0242; G06Q 30/0277

(57) ABSTRACT

The present invention provides a promotion system and a promotion method, where the promotion system includes: a producing module, configured to produce a display material; a setting module, configured to set the display material produced by the producing module; and a releasing module, configured to release the display material set by the setting module to different social networks via different release channels. According to the advertisement promotion system provided in embodiments of the present invention, the producing module completes production of the display material, the setting module completes design of the display material, and finally the releasing module releases the display material which has been produced and set to various social networks via release channels provided by the promotion system, thereby helping a user to autonomously complete production, setting and release of an enterprise display material, and reducing promotion cost.

### CROSS-REFERENCE TO RELATED APPLICATIONS

This application claims priority to Chinese Patent Application No. 201510930078.8, filed on Dec. 15, 2015, entitled “Promotion System and Promotion Method”, which is hereby incorporated by reference in its entirety.

### TECHNICAL FIELD

The present invention relates to promotion technologies and, in particular, to a promotion system and a promotion method.

### BACKGROUND

With rapid development of mobile internet technologies, more and more enterprises perform advertisement promotion via the internet to strengthen product publicity.

Generally, during a process where a large enterprise is performing advertisement promotion, an exquisite display material is produced via a professional advertisement team, and the display material is released to the internet. Particularly, the display material is content presented by an advertisement, and types thereof include texts, pictures, animations, etc. The internet releasing the display material is a few network enterprises, such as Tencent, Baidu.

However, during the above advertisement promotion, a professional team is required to produce a display material, which is intolerable for small and medium-sized enterprises with thin profits due to extremely high cost for advertisement promotion. Moreover, during the above advertisement promotion, the display material needs to be released to a few network enterprises, and releasing cost is relatively high, which will further increase the cost for advertisement promotion of small and medium-sized enterprises.

### SUMMARY

The present invention provides a promotion system and a promotion method. Production and release of a display material are completed autonomously by a user via the promotion system, thus promotion cost is reduced.

In a first aspect, an embodiment of the present invention provides a promotion system, including:

a producing module, configured to produce a display material;

a setting module, configured to set the display material produced by the producing module; and

a releasing module, configured to release the display material set by the setting module to different social networks via different release channels.

In a first possible implementation of the first aspect, the promotion system also includes:

a data counting module, configured to count a release effect of the display material released by the releasing module, and optimize content of the display material and/or the release channels according to the release effect;

the releasing module is configured to release the display material according to the optimized content of the display material and/or the optimized release channels.

With reference to the first possible implementation of the first aspect, in a second possible implementation of the first aspect, the release effect includes at least one of pieces of information as follows: number of times of the display material being accessed per unit time, number of times of the display material being accessed via each release channel in different release channels, and number of times of a customer interacting with the display material; correspondingly,

the data counting module includes at least one of the following modules:

an access summarizing module, configured to count number of times of the display material being accessed per unit time;

a mobile accessing module, configured to count number of times of the display material being accessed via each release channel in different release channels; and

a content counting module, configured to count number of times of a customer interacting with the display material.

In a third possible implementation of the first aspect, the promotion system also includes:

a data managing module, configured to manage data collected by the display material.

With reference to any possible implementation of the first aspect and the first possible implementation to the third possible implementation of the first aspect, in a fourth possible implementation of the first aspect, the promotion system also includes:

a show module, configured to share the display material set by the setting module.

With reference to any possible implementation of the first aspect and the first possible implementation to the third possible implementation of the first aspect, in a fifth possible implementation of the first aspect, the promotion system also includes: an operation managing module, configured to manage the producing module, the setting module and the releasing module.

With reference to any possible implementation of the first aspect and the first possible implementation to the third possible implementation of the first aspect, in a sixth possible implementation of the first aspect, the producing module includes:

a template component, configured to store at least one display material producing template;

an element component, configured to provide a tool for producing the display material;

a page component, configured to perform page level management to the display material; and

an editing module, configured to edit, according to the tool for producing the display material provided by the element component and the page level management provided by the page component, a target template selected from the at least one display material producing template stored by the template component.

With reference to the first aspect, any possible implementation of the first possible implementation to the third possible implementation of the first aspect, in a seventh possible implementation of the first aspect, the setting module is specifically configured to set basic attributes and/or scenario sharing of the display material produced by the producing module.

In a second aspect, an embodiment of the present invention provides a promotion method, including:

producing a display material;

setting the display material; and

releasing the set display material to different social networks via different release channels.

In a first possible implementation of the second aspect, after releasing the set display material to different social networks via different release channels, the method further includes:

counting a release effect of the display material, and optimizing content of the display material and/or the release channels according to the release effect; and

releasing the display material according to the optimized content of the display material and/or the optimized release channel.

With reference to the first possible implementation of the second aspect, in a second possible implementation of the second aspect, the release effect includes at least one of pieces of information as follows: number of times of the display material being accessed per unit time, number of times of the display material being accessed via each release channel in different release channels, and number of times of a customer interacting with the display material; correspondingly, data counting includes at least one of pieces of information as follows: number of times of the display material being accessed per unit time; number of times of the display material being accessed via each release channel in different release channels; and number of times of a customer interacting with the display material.

In a third possible implementation of the second aspect, the method also includes:

managing data collected by the display material.

In a fourth possible implementation of the second aspect, the method also includes:

sharing the display material.

With reference to the second aspect, the first or the second possible implementation of the second aspect, in a fifth possible implementation of the second aspect, the method also includes: storing at least one display material producing template; providing a tool for producing the display material; performing page level management to the display material; and editing, according to the tool for producing the display material and the page level management, a target template selected from the at least one display material producing template.

With reference to the second aspect, the first or the second possible implementation of the second aspect, in a sixth possible implementation of the second aspect, the setting the display material includes:

setting basic attributes and/or scenario sharing of the display material.

In a third aspect, an embodiment of the present invention also provides a promotion system. The promotion system includes: a processor and a memory, where the memory stores an execution instruction, when the promotion system runs, the processor communicates with the memory, and the processor executes the execution instruction to enable the promotion system to perform a method according to any one of the second aspect and the first possible implementation to the sixth possible implementation of the second aspect.

According to the promotion system and the promotion method provided in embodiments of the present invention, the producing module completes production of the display material, the setting module completes design of the display material, and finally the releasing module releases the display material which has been produced and set to various social networks via release channels provided by the promotion system. With the help of mutual promotion and coordination of these modules, production, setting and release of an enterprise display material are completed by a user autonomously, thus promotion cost is reduced.

### BRIEF DESCRIPTION OF DRAWINGS

FIG. 1 is a schematic structural diagram of a promotion system according to an embodiment of the present invention;

FIG. 2 is a schematic structural diagram of a promotion system according to another embodiment of the present invention;

FIG. 3 is a schematic diagram of a producing interface of a graphical user interface according to an embodiment of the present invention;

FIG. 4 is a schematic diagram of a setting interface of a graphical user interface according to an embodiment of the present invention;

FIG. 5 is a schematic diagram of a releasing interface of a graphical user interface according to an embodiment of the present invention;

FIG. 6 is a flowchart of a promotion method according to an embodiment of the present invention;

FIG. 7 is a schematic structural diagram of a promotion system according to still another embodiment of the present invention.

### DESCRIPTION OF EMBODIMENTS

In order to make objectives, technical solutions and advantages of embodiments of the present invention clearer, the technical solutions in the embodiments of the present invention will be described hereunder clearly and comprehensively with reference to accompanying drawings in the embodiments of the present invention. Obviously, the described embodiments are only a part of embodiments of the present invention, rather than all embodiments of the present invention. All other embodiments obtained by persons skilled in the art based on the embodiments of the present invention herein without any creative effort shall fall into the protection scope of the present invention.

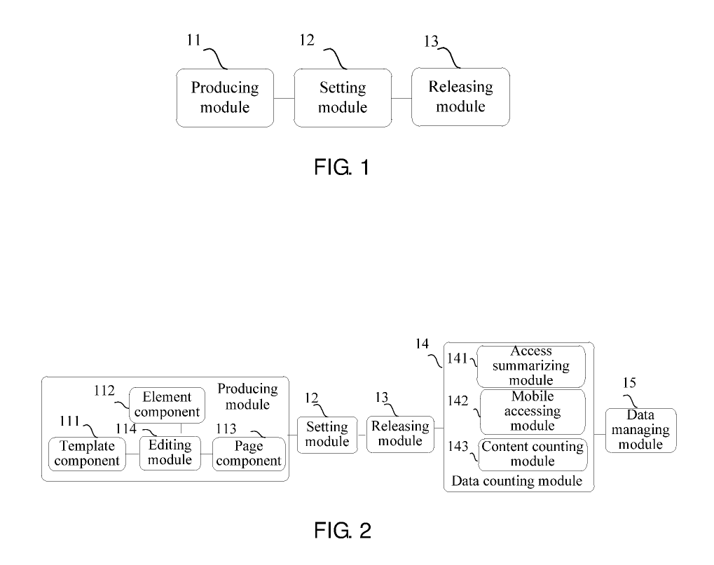

FIG. 1 is a schematic structural diagram of a promotion system according to an embodiment of the present invention. As shown in FIG. 1, the promotion system provided in the embodiment of the present invention includes:

a producing module 11, configured to produce a display material;

a setting module 12, configured to set the display material produced by the producing module 11; and

a releasing module 13, configured to release the display material set by the setting module 12 to different social networks via different release channels.

The advertisement promotion system according to the embodiment of the present invention can be operated on various user equipments (User Equipment, UE), for instance, be operated on a desktop computer or a mobile phone. For instance, a user may log in to the promotion system on a computer desktop via an account or the like, and may also log in on a user equipment. The computer is used to produce a display material and the like, and the user equipment is used to view access to the display material and the like at any time any where.

Specifically, in the promotion system, the producing module 11 provides a WYSIWYG (what you see is what you get) edit mode to produce a display material. When the producing module 11 is producing the display material, or after the producing module 11 completes production of the display material, the setting module 12 performs overall settings to the display material, these settings include basic settings, sharing settings and friendship presentation of the display material etc. Through the basic settings, a name and a brief description of the display material, a cover of the display material, a connection mode of each presentation within the display material, an access password of the display material and the like may be set; through the sharing settings, the display material may be added into a display platform and various associated activities provided by the promotion system; through the friendship presentation, information about a provider of the display material may be showed to the user, such as a link address of a company homepage, for instance, a link to the company homepage is added on the last page of the display material, so as to promote the company.

The releasing module 13 releases the display material which has been produced and set to an associated social network via a release channel provided by the promotion system. Specifically, the release may be performed purposefully with reference to a user demand During the release, the releasing module 13 may use a plurality of manners to release the display material to different social networks via different release channels. For example, the releasing module 13 may provide a unique QR(quick response) code for each display material, and the display material is released to various social networks by means of scanning the QR code by a mobile device. The QR code may be downloaded and deployed to other channels via an image, thereby achieving scanning view of the display material online and offline. For another example, by means of one-touch sharing, the releasing module 13 directly shares the display material to a mainstream socialization channel on a desktop of a user equipment, such as Weibo, Douban, etc. For still another example, the releasing module 13 may also set an extension name for a network address of the display material, or use different QR codes, and release the display material to different social networks according to the extension names, thus monitoring and management of release effects of different release channels are achieved, and the user can conveniently make an assessment to a release effect of each release channel subsequently.

According to the advertisement promotion system provided in the embodiment of the present invention, the producing module completes production of the display material, the setting module completes design of the display material, and finally the releasing module releases the display material which has been produced and set to various social networks via release channels provided by the promotion system. With the help of mutual promotion and coordination of these modules, production, setting and release of an enterprise display material are completed by a user autonomously; with the help of power of friend relationships, the display material is promoted on a social medium platform, and the promotion is boosted by social relationships, thus promotion cost is reduced.

Alternatively, in the above embodiment, the producing module 11 includes: a template component 111, configured to store at least one display material producing template; an element component 112, configured to provide a tool for producing the display material; a page component 113, configured to perform page level management to the display material; and an editing module 114, configured to edit, according to the tool for producing the display material provided by the element component 112 and the page level management provided by the page component 113, a target template selected from the at least one display material producing template stored by the template component. Specifically, reference may be made to FIG. 2, which is a schematic structural diagram of a promotion system according to another embodiment of the present invention.

Specifically, the template component 111 stores at least one display material producing template, and has powerful intelligent template resources, which enables the user to quickly produce an exquisite display material by means of selecting a template and editing the template without professional training. For instance, the template component 111 provides an independent enterprise template, and generates templates of a consistent style etc for the enterprise; in combination with authorization of a sub-account number of the enterprise, when the enterprise logs in to the promotion system, a display material may be produced, set and released conveniently by using the enterprise templates.

The element component 112 provides a tool required for producing the display material. The tool includes: a text, a show font, an image, a background, a shape, a video, music, a pattern, interaction, a form, a special effect, etc. During a process where the user is producing the display material, with reference to a target manifestation and a release channel of the display material, these tools are used in combination, and finally a desirable display material is produced by modifying the target template etc.

The page component 113 is an area in which page level management is performed to the display material, and page addition, deletion, insertion, copy, name edit and sequence adjustment of the display material and the like are performed via the page component 113.

As a preferred manner, in an interface of the promotion system, the editing module 114 is placed centrally, the template component 111 is on the left of the editing module 114, the element component 112 is above the editing module 114, and the page component 113 is on the right of the editing module 114, thus full consideration is given to user behaviors during an actual operation.

Reference may be made to FIG. 2 again, in an embodiment of the present invention, the promotion system may also include a data counting module 14, configured to count a release effect of the display material released by the releasing module, and optimize content of the display material and/or the release channels according to the release effect; the releasing module 13 is configured to release the display material according to the optimized content of the display material and/or the optimized release channels.

Specifically, the data counting module 14 may count, by means of a chart, the release effect of the display material released by the releasing module 13, in order that the user tracks an actual release effect of the display material. The release effect is presented in the chart in a manner of data, and the user optimizes the content of the display material, the release channels and the like in real time or periodically according to these data. Thus, through the promotion system, the user can conveniently view access to its own display material, and meanwhile data about the browsing user is collected, and after analysis thereon, the promotion strategy is further adjusted, that is, optimizing the content of the display material or the release channels or the like, thereby achieving a self-marketing loop of “promotion”→“collection”→“analysis”→“re-promotion”.

The release effect includes at least one of pieces of information as follows: number of times of the display material being accessed per unit time, number of times of the display material being accessed via each release channel in different release channels, and number of times of a customer interacting with the display material; correspondingly, the data counting module 14 includes at least one of the following modules: an access summarizing module 141, configured to count number of times of the display material being accessed per unit time, for instance, “day” is taken as a unit to count number of times of the display material being accessed per day; a mobile accessing module 142, configured to count number of times of the display material being accessed via each release channel in different release channels, for instance, for each type of release channel, “day” is taken as a unit to count number of times of a customer accessing the display material via this type of release channel per day; and a content counting module 143, configured to count number of times of a customer interacting with the display material, for instance, number of times of a user clicking a like component in the display material, etc. Moreover, comprehensively detailed data counting may also be performed according to a geographic position, a device type, etc.

Reference may be made to FIG. 2 again, in an embodiment of the present invention, the promotion system may also include: a data managing module 15, configured to manage data collected by the display material.

Specifically, when the display material of the user contains a data collecting form for a target customer, the data managing module 15 imports these data collected by the display material to a customer data sheet via an import tool unitedly, addition, deletion, modification, querying, group management and the like are performed on the data in the customer data sheet, and these data is downloaded to a local desktop computer. The content of the display material and the channels for release and promotion are further optimized through management and analysis of these data, thus a new display material is created according to characteristics of these data so as to perform secondary released promotion and marketing, thereby forming a socialized self-promoting closed loop for small and medium-sized enterprises, and continuously performing socialized self-marketing for target customers and existing customers.

Reference may be made to FIG. 2 again, in an embodiment of the present invention, the promotion system may also include: a show module 16, configured to share the display material set by the setting module 12.

Specifically, after the user completes production and setting of the display material, the display material may be shared to a show. The display material which is shared to the show may obtain more opportunities of being browsed, meanwhile, the promotion system may also guide more browsing to the show via resource optimization, and the display material is released through the show. Some display materials in the show may also be provided by the promotion system itself or be provided by a third party, capable of being used as a template sample. Thus, by means of classifying and searching, the user can dig out a target sample in the show as required, and produce a display material which is in compliance with his own demand according to the target sample. Further, the user finds out an author of the target sample through the show, and produces a display material which is in compliance with his own demand through an assist of the author, thus a communication platform is established for a user having a customization requirement and a user providing customization, thereby completing the customized requirement. That is to say, by sharing of the show module, the user is provided with diversified production needs for a display material, and meanwhile release channels for the display material are increased for the user, varieties of needs during the operation, such as brand publicity, product promotion, personnel recruitment, internal management, may be met for various industries, including media, government agencies and public organizations.

Reference may be made to FIG. 2 again, in an embodiment of the present invention, the promotion system may also include: an operation managing module 17, configured to manage the producing module 11, the setting module 12 and the releasing module 13.

Specifically, the operation managing module 17 is a non-user-oriented important extension component in the promotion system, which is used for backstage management. Operation management of the promotion system is achieved through the operation managing module 17 managing the producing module 11, the setting module 12 and the releasing module 13, thereby guaranteeing realization of operation of the promotion system and the user value. For instance, management is performed to a user, a display material, a message, a site, data, an order, an interface, etc.

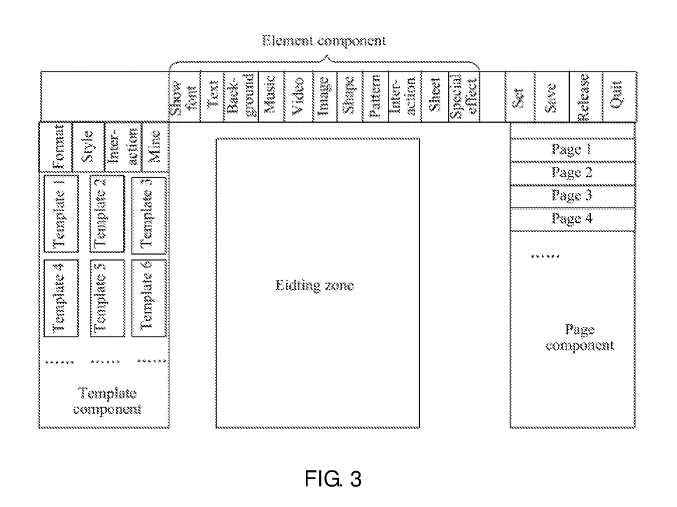

FIG. 3 is a schematic diagram of a producing interface of a graphical user interface according to an embodiment of the present invention. As shown in FIG. 3, the graphical user interface provided in this embodiment includes:

a producing interface, configured to produce a display material;

a setting button, configured to enter a setting interface to set the display material produced by the producing interface;

a releasing button, configured to enter a release interface to release the display material which is set in the setting interface to different social networks via different release channels.

Specifically, reference may be made to FIG. 3, in the embodiment of the present invention, click, in the graphical user interface opened by logging via a user account or double-clicking, a button of Create to enter the producing interface, where the producing interface used for producing the display material is divided into four areas roughly: an editing zone placed centrally, a template component on the left of the editing zone, an element component above the editing zone, and a page component on the right of the editing zone. The template component is used to store at least one display material producing template; the element component is used to provide a tool for producing the display material; the page component is used to perform page level management to the display material; and the editing zone is used to edit, according to the tool for producing the display material provided by the element component and the page level management provided by the page component, a target template selected from the at least one display material producing template stored by the template component.

During the use of the graphical user interface, a template is selected via the template component, for example, by clicking the format button in the area of the template component, format sub-options are shown, such as an image-text template (page elements include graphics and characters), a character template (page elements include characters), and templates of different formats are selected as required; for another example, by clicking the style in the area of the template component, style sub-options are shown, such as a cartoon style, a game style, etc. After a template is selected, the selected template occurs in the editing zone.

In the editing zone, the template is modified through the element component to produce a desired display item. During the production, modifications on characters, graphics, and animations and so on are made to the display material through the element component.

Generally, the produced display material has more than one page. Thus, page level management may be performed to the display material in the area of the page component. For example, by selecting Page 2 in the page component, the Page 2 is shown in the editing zone correspondingly, at this time, the user can edit the Page 2. For another example, the user can perform page addition, deletion, insertion, copy, name edit and sequence adjustment and so on to the display material in the area of the page component directly.

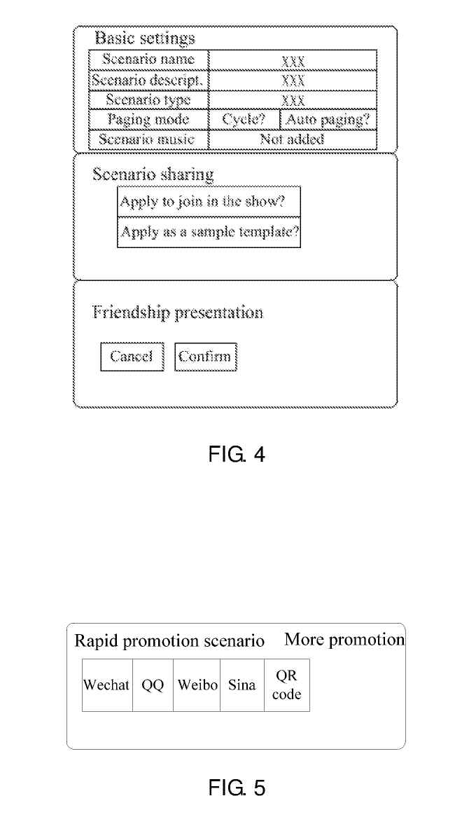

After production of the display material is completed, click the setting button in the upper right corner to enter the setting interface. Basic attributes and/or scenario sharing of the display material produced by the producing interface are set in the setting interface. Specifically, reference may be made to FIG. 4, which is a schematic diagram of a setting interface of a graphical user interface according to an embodiment of the present invention.

Reference may be made to FIG. 4, and in this embodiment, the setting interface is divided into three areas roughly: a basic setting area, a scenario sharing area and a friendship presentation area. Through the basic settings, a name and a brief description of the display material, a cover of the display material, a connection mode of each presentation within the display material, an access password of the display material and the like may be set; through the sharing settings, the display material may be added into a display platform, a show and various associated activities provided by the promotion system; through the friendship presentation, information about a provider of the display material may be showed to the user, such as a link address of a company homepage, for instance, a link to the company homepage is added on the last page of the display material, so as to promote the company.

After production and setting of the display material are completed, click the releasing button in the upper right corner to enter the releasing interface, specifically, reference may be made to FIG. 5, which is a schematic diagram of a releasing interface of a graphical user interface according to an embodiment of the present invention.

Reference may be made to FIG. 5, and in this embodiment, the releasing interface may provide various types of release channels to enable the user to release the display material which has been produced and set to associated social networks via release channels provided by the promotion system. Specifically, the release may be performed purposefully with reference to a user demand During the release, the releasing interface may use a plurality of manners to release the display material to different social networks via different release channels. For example, a unique QR(quick response) code may be provided for each display material, and the display material is released to various social networks by means of scanning the QR code by a mobile device. For another example, by means of one-touch sharing, the display material is directly shared to a mainstream socialized channel on a desktop of a user equipment, such as Weibo, Douban, QQ, etc.

In order to achieve optimization of the content of the display material and/or the release channels according to the release effect, the graphical user interface according to the present invention also includes a data counting interface. Specifically, click, in the graphical user interface opened by logging via a user account or double-clicking, a button of Data Counting to enter the data counting interface to count a release effect of the display material released by the releasing interface, thus the content of the display material and/or the release channels are optimized according to the release effect, and then the release interface is enabled to release the display material according to the optimized content of the display material and/or the optimized release channels. The release effect includes at least one of pieces of information as follows: number of times of the display material being accessed per unit time, number of times of the display material being accessed via each release channel in different release channels, and number of times of a customer interacting with the display material; correspondingly, the data counting includes at least one of pieces of information as follow: number of times of the display material being accessed per unit time; number of times of the display material being accessed via each release channel in different release channels; and number of times of a customer interacting with the display material.

Moreover, click, in the graphical user interface opened by logging via an account or double clicking, a button of Management to enter the data managing interface. Specifically, when the display material of the user contains a data collecting form for a target customer, these data collected by the display material may be imported to a customer data sheet via an import tool unitedly, addition, deletion, modification, querying and group management and the like are performed on the data in the customer data sheet, and these data is downloaded to a local desktop computer. The content of the display material and the channels for release and promotion are further optimized through management and analysis of these data, thus a new display material is created according to characteristics of these data so as to perform secondary released promotion and marketing, thereby forming a socialized self-promoting closed loop for small and medium-sized enterprises, and continuously performing socialized self-marketing for target customers and existing customers.

According to the user interface provided in the embodiment of the present invention, the display material is finally released to various social networks via the release channels by producing the display material and setting the produced display material. During this process, production, setting and release of an enterprise display material are completed by a user autonomously; with the help of power of friend relationships, the display material is promoted on a social medium platform, and the promotion is boosted by social relationships, thus promotion cost is reduced.

Moreover, an embodiment of the present invention also provides a computer program, where the computer program is stored in a readable storage medium, and the computer program is used to enable a computer to perform processing procedures of:

producing a display material;

setting the display material; and

releasing the display material to different social networks via different release channels.

According to the computer program provided in the embodiment of the present invention, the display material is finally released to various social networks via the release channels by producing the display material and setting the produced display material. During this process, production, setting and release of an enterprise display material are completed by a user autonomously; with the help of power of friend relationships, the display material is promoted on a social medium platform, and the promotion is boosted by social relationships, thus promotion cost is reduced.

Alternatively, in an embodiment of the present invention, the computer program is also used to enable the computer to count a release effect of the released display material; optimize content of the display material and/or the release channels according to the release effect; and release the display material according to the optimized content of the display material and/or the optimized release channels.

Alternatively, in an embodiment of the present invention, the release effect includes at least one of pieces of information as follows: number of times of the display material being accessed per unit time, number of times of the display material being accessed via each release channel in different release channels, and number of times of a customer interacting with the display material; correspondingly, the data counting includes at least one of pieces of information as follows: number of times of the display material being accessed per unit time; number of times of the display material being accessed via each release channel in different release channels; and number of times of a customer interacting with the display material.

Alternatively, in an embodiment of the present invention, the computer program is also used to enable the computer to manage data collected by the display material.

Alternatively, in an embodiment of the present invention, the computer program is also used to enable the computer to share the display material.

Alternatively, in an embodiment of the present invention, the computer program is also used to enable the computer to store at least one display material producing template; provide a tool for producing the display material; perform page level management to the display material; and edit, according to the tool and the page level management, a target template selected from the at least one display material producing template.

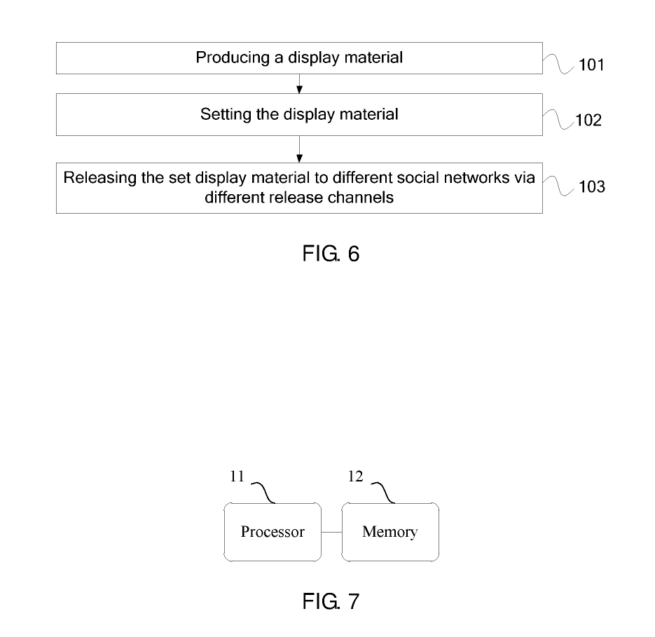

FIG. 6 is a flow chart of a promotion method according to an embodiment of the present invention. The promotion method provided in this embodiment is a method embodiment corresponding to the embodiment of FIG. 1 of the present invention, and specific implementations thereof will not be repeated herein. Specifically, the promotion method provided in this embodiment includes:

101, producing a display material;

102, setting the display material; and

103, releasing the set display material to different social networks via different release channels.

According to the promotion method provided in the embodiment of the present invention, the display material is finally released to various social networks via the release channels by producing the display material and setting the produced display material. During this process, production, setting and release of an enterprise display material are completed by a user autonomously; with the help of power of friend relationships, the display material is promoted on a social medium platform, and the promotion is boosted by social relationships, thus promotion cost is reduced.

Alternatively, in an embodiment of the present invention, after releasing the set display material to different social networks via different release channels, the method further includes: counting a release effect of the display material, and optimizing content of the display material and/or the release channels according to the release effect; releasing the display material according to the optimized content of the display material and/or the optimized release channels.

Alternatively, in an embodiment of the present invention, the release effect includes at least one of pieces of information as follows: number of times of the display material being accessed per unit time, number of times of the display material being accessed via each release channel in different release channels, and number of times of a customer interacting with the display material; correspondingly, the data counting includes at least one of pieces of information as follows: number of times of the display material being accessed per unit time; number of times of the display material being accessed via each release channel in different release channels; and number of times of a customer interacting with the display material.

Alternatively, in an embodiment of the present invention, the method also includes: managing data collected by the display material.

Alternatively, in an embodiment of the present invention, the method also includes: sharing the display material.

Alternatively, in an embodiment of the present invention, the method also includes: storing at least one display material producing template; providing a tool for producing the display material; performing page level management to the display material; and editing, according to the tool for producing the display material and the page level management, a target template selected from the at least one display material producing template.

Alternatively, in an embodiment of the present invention, the setting the display material includes:

setting basic attributes and/or scenario sharing of the display material.

Moreover, based on the above method, an embodiment of the present invention also provides a promotion system. Specifically, reference may be made to FIG. 7, which is a schematic structural diagram of a promotion system according to still another embodiment of the present invention. The promotion system provided in this embodiment is an embodiment corresponding to the embodiment of FIG. 1 of the present invention, and specific implementations thereof will not be repeated herein. Specifically, the promotion system provided in this embodiment includes: a processor 11 and a memory 12, where the memory 12 stores an execution instruction, when the promotion system runs, the processor 11 communicates with the memory 12, and the processor 11 executes the execution instruction to enable the promotion system to perform a method as shown in FIG. 6.

Persons of ordinary skill in the art may understand that, all or a part of steps of the foregoing method embodiments may be implemented by a program instructing relevant hardware. The foregoing program may be stored in a computer readable storage medium. When the program runs, the steps of the foregoing method embodiments are performed. The foregoing storage medium includes various mediums capable of storing program codes, such as a ROM, a RAM, a magnetic disk, or an optical disc.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments, or make equivalent replacements to some or all technical features therein; however, these modifications or replacements do not make the essence of corresponding technical solutions depart from the scope of the technical solutions in the embodiments of the present invention.

What is claimed is:

1. A promotion system, comprising:
a producing module, configured to produce a display material;
a setting module, configured to set the display material produced by the producing module; and
a releasing module, configured to release the display material set by the setting module to different social networks via different release channels.

2. The promotion system according to claim 1, further comprising:
a data counting module, configured to count a release effect of the display material released by the releasing module, and optimize content of the display material and/or the release channels according to the release effect;
the releasing module is configured to release the display material according to the optimized content of the display material and/or the optimized release channels.

3. The promotion system according to claim 2, wherein, the release effect comprises at least one of pieces of information as follows: number of times of the display material being accessed per unit time, number of times of the display material being accessed via each release channel in the different release channels, and number of times of a customer interacting with the display material; correspondingly,
the data counting module comprises at least one of the following modules:
an access summarizing module, configured to count number of times of the display material being accessed per unit time;
a mobile accessing module, configured to count number of times of the display material being accessed via each release channel in the different release channels; and
a content counting module, configured to count number of times of the customer interacting with the display material.

4. The promotion system according to claim 1, further comprising:
a data managing module, configured to manage data collected by the display material.

5. The promotion system according to claim 1, further comprising:
a show module, configured to share the display material set by the setting module.

6. The promotion system according to claim 1, further comprising:
an operation managing module, configured to manage the producing module, the setting module and the releasing module.

7. The promotion system according to claim 1, wherein, the producing module comprises:
a template component, configured to store at least one display material producing template;
an element component, configured to provide a tool for producing the display material;
a page component, configured to perform page level management to the display material; and
an editing module, configured to edit, according to the tool for producing the display material provided by the element component and the page level management provided by the page component, a target template selected from the at least one display material producing template stored by the template component.

8. The promotion system according to claim 1, wherein, the setting module is specifically configured to set basic attributes and/or scenario sharing of the display material produced by the producing module.

9. A promotion method, comprising:
producing a display material;
setting the display material; and
releasing the set display material to different social networks via different release channels.

10. The method according to claim 9, wherein, after releasing the set display material to different social networks via different release channels, the method further comprises:
counting a release effect of the display material, and optimizing content of the display material and/or the release channels according to the release effect; and
releasing the display material according to the optimized content of the display material and/or the optimized release channels.

11. The method according to claim 10, wherein, the release effect comprises at least one of pieces of information as follows: number of times of the display material being accessed per unit time, number of times of the display material being accessed via each release channel in the different release channels, and number of times of a customer interacting with the display material; correspondingly, data counting comprises at least one of pieces of information as follows: number of times of the display material being accessed per unit time; number of times of the display material being accessed via each release channel in the different release channels; and number of times of a customer interacting with the display material.

12. The method according to claim 9, further comprising:
managing data collected by the display material.

13. The method according to claim 9, further comprising:
sharing the display material.

14. The method according to claim 9, further comprising: storing at least one display material producing template; providing a tool for producing the display material;
performing page level management to the display material; and editing, according to the tool for producing the display material and the page level management, a target template selected from the at least one display material producing template.

15. The method according to claim 9, wherein, the setting the display material comprises:
setting basic attributes and/or scenario sharing of the display material.

16. A promotion system, comprising: a processor and a memory, wherein the memory stores an execution instruction, when the promotion system runs, the processor communicates with the memory, and the processor executes the execution instruction to enable the promotion system to perform a method according to claim 9.
